(19) United States
(12) Patent Application Publication
(10) Pub. No.: US 2014/0172959 A1
(43) Pub. Date: Jun. 19, 2014

(54) GATEWAY AND DEVICE MANAGEMENT METHOD

(71) Applicant: HON HAI PRECISION INDUSTRY CO., LTD., New Taipei (TW)

(72) Inventor: KUANG-WU HSU, New Taipei (TW)

(73) Assignee: HON HAI PRECISION INDUSTRY CO., LTD., New Taipei (TW)

(21) Appl. No.: 14/092,901

(22) Filed: Nov. 27, 2013

(30) Foreign Application Priority Data
Dec. 17, 2012 (TW) 101147705

(51) Int. Cl. H04L 29/06

(52) U.S. Cl. CPC H04L 67/42
USPC 709/203

(57) ABSTRACT

A gateway communicates with at least one terminal device and a database server. When the terminal device is connected to the gateway, device identification (ID) of the terminal device is acquired to download a device description frame (DDF) file of the terminal device from the database server. Then, detailed information of the terminal device is displayed on a user interface according to the DDF file. When a command is sent using the user interface, the commands is received and transmitted to the terminal device, to control the terminal device to perform a corresponding function.

### BACKGROUND

1. Technical Field

Embodiments of the present disclosure relate to a gateway and a device management method using the gateway.

2. Description of Related Art

The digital living network alliance (DLNA) is a non-profit collaborative trade organization responsible for defining interoperability guidelines to enable sharing of digital media between multimedia devices. DLNA devices can interconnect with each other to share digital media with each other. However, different devices may have different functions and different user interfaces. Thus, a user needs to learn the different functions and user interfaces to manage each device, which is inconvenient. Therefore, there is room for improvement in the art.

### BRIEF DESCRIPTION OF THE DRAWINGS

FIG. 1 is a schematic diagram illustrating one embodiment of a gateway communicated with a plurality of terminal devices.

FIG. 2 is a schematic block diagram of the gateway of FIG. 1 including a plurality of functional modules.

FIG. 3 is a flowchart of one embodiment of a device management method implemented by the gateway of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

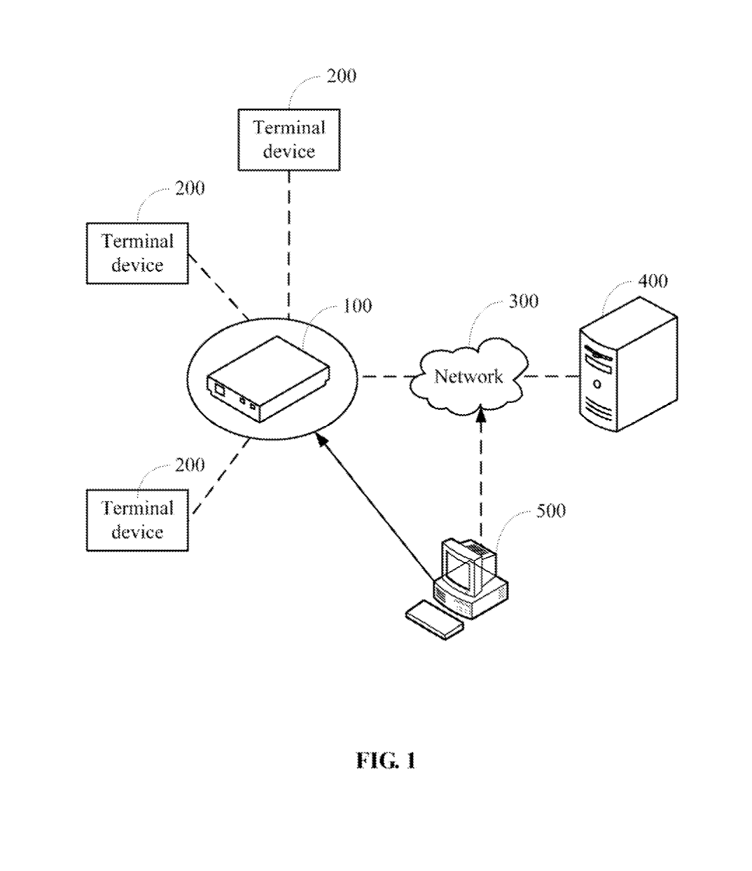

FIG. 1 shows a gateway 100 of the illustrated embodiment. The gateway 100 is used to connect at least one terminal device 200 to a network 300, to establish a network communication between the at least one terminal device 200 and the network 300. The gateway 100 is connected to the at least one terminal device 200 via a wired connection (e.g., via cable line or data line) or via a wireless connection (e.g., via BLUETOOTH® or WIFI®). The gateway 200 may be, for example, a modem, a router, or other similar devices. The at least one terminal device 200, may be a smart phone, a palm computer, a mobile Internet device (MID), for example. In other embodiments, the at least one terminal device 200 can be household electrical appliances, such as digital televisions, smart washing machines, and refrigerators.

In this embodiment, the at least one terminal device 200 can be remotely controlled by a control device 500 (e.g., a computer). The control device 500 can directly connect to the gateway 100 via the wired connection or the wireless connection or remotely connect to the gateway 100 via the network 300. The gateway 100 can be accessed by the control device 500 and a command can be sent to the at least one terminal device 200 via the gateway 100 to manage or control the at least one terminal device. For example, a command is sent to control the at least one device 200 to perform a corresponding function. In other embodiments, when the gateway 100 is connected to two or more terminal devices 200, the control device 500 can be replaced by one of the terminal devices 200.

In this embodiment, both the at least one terminal device 200 and the gateway 100 support an open mobile alliance device management (OMADM) specific, to allow the gateway 100 to manage or control the at least one terminal device 200. The OMADM specific is a standard developed by the open mobile alliance (OMA), which allows remote configuration of mobile devices (e.g., the terminal device 200). The remote configuration includes, for example, setting of device parameters, obtaining troubleshooting information, installing or upgrading software, of the at least one terminal device 200.

In addition, the gateway 100 is connected to a database server 400 via the network 300. The database server 400 stores a device description frame (DDF) file of each terminal device 200. The DDF file is extensible markup language (XML) formatted, which describes management objects (MO) support the OMADM specific of each terminal device 200. When the gateway 100 obtains the DDF file of the at least one terminal device 200, the management objects described in the DDF file can be remotely manipulated via the gateway 100. Each element which can be definitely defined of the at least one terminal device 100 can be regarded as a management object. For example, the management objects may include applications, single functions, service settings, firmware, middleware components, and an operating system of the at least one terminal device 100. The OMADM represents all available management objects of a single device as a hierarchical tree structure where all nodes can be uniquely addressed with uniform resource identifiers (URI). This structure is called device management tree (DMT). According to the OMADM specific, the manufacturer of the terminal device 100 should submit a parameter configuration (e.g., the DDF file which describes the DMT) of the terminal device 100. Thus, the database server 400 which stores the DDF file can be provided by the open mobile alliance.

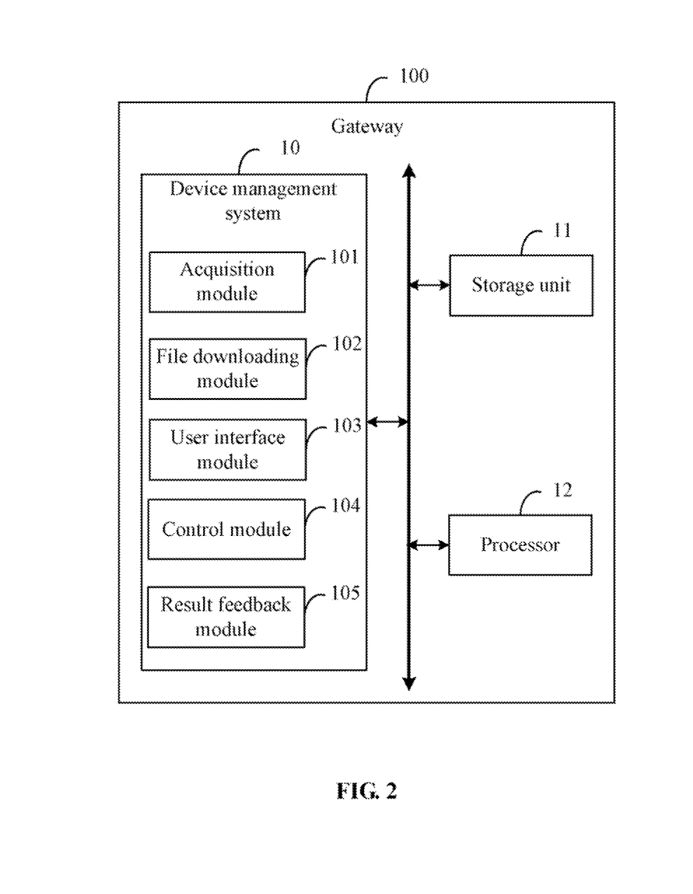

FIG. 2 is a schematic block diagram of the gateway 200 of FIG. 1. The gateway 200 includes a device management system 10, a storage unit 11, and a processor 12. The device management system 10 includes a plurality of functional modules. Each of the functional modules may include a plurality of programs in the form of one or more computerized instructions stored in the storage unit 11 and executed by the processor 12 to perform operations of the gateway 100. In the embodiment, the device management system 10 includes an acquisition module 101, a file downloading module 102, a user interface module 103, a control module 104, and a result feedback module 105.

In general, the word “module”, as used herein, refers to logic embodied in hardware or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or hardware modules and may be stored in any type of non-transitory computer-readable medium or other storage devices. Some non-limiting examples of non-transitory computer-readable medium include CDs, DVDs, BLU-RAY, flash memory, and hard disk drives.

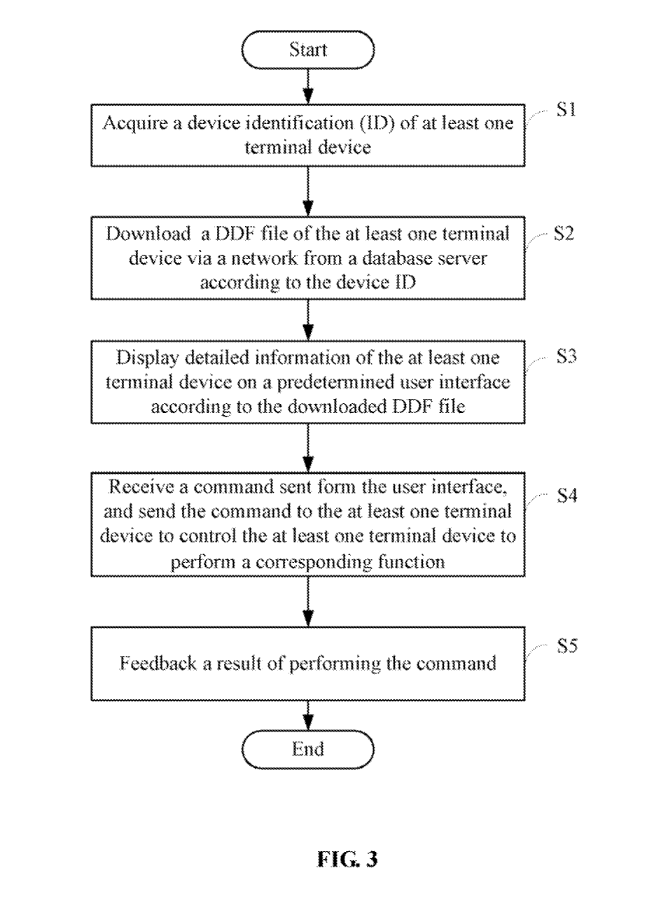

FIG. 3 shows a flowchart of one embodiment of a device management method implemented by the functional modules of the device management system 10 of FIG. 2. Depending on the embodiment, additional steps may be added, others removed, and the ordering of the steps may be changed.

In step S1, when the at least one terminal device 200 is connected to the gateway 100, the acquisition module 101 acquires a device identification (ID) of the at least one terminal device 200. The device ID may be a unique device identification, such as an international mobile equipment identity (IMEI) of the at least one terminal device 200. In this embodiment, when the terminal device 200 is connected to the gateway 100, a dynamic host configuration protocol (DHCP) package is sent from the at least one terminal device 200 to the gateway 100. The acquisition module 101 can acquire the device ID of the at least one terminal device 200 from the DHCP package.

In step S2, the file downloading module 102 downloads the DDF file of the at least one terminal device 200 via the network from the database server 400 according to the device ID of the at least one terminal device 200, and stores the DDF file in the storage unit 11.

In this embodiment, the file downloading module 102 first searches the database server 400 for a download address (e.g., HTTP address) of the DDF file using the device ID, and then links to the download address via the network 300 to download the DDF file. In other embodiments, the download address may be pre-configured in the DHCP package. The file downloading module 102 first acquires the download address of the DDF file from the DHCP package, and then link to the download address via the network 300 to download the DDF file. The download address of the DDF file can be preset in the DHCP package by a manufacturer of the at least one terminal device 200.

In step S3, the user interface module 103 displays detailed information of the at least one terminal device 200 on a predetermined user interface according to the downloaded DDF file.

In this embodiment, the step S3 is implemented when the gateway 100 is accessed by the control device 500, to display the information of the at least one terminal device 200 to the user via the user interface. The user interface may be a webpage provided by the gateway 100. The gateway 100 can be accessed using a browser of the control device 500. When the gateway 100 is accessed by the control device 500, the webpage is displayed on a display of the control device 500. When the detailed information of the at least one terminal device 200 is displayed on the user interface, a command can be sent via the user interface to remotely manipulate the at least one terminal device 200, such as upgrade software of the at least one terminal device 200. Further, the user interface may include a plurality of operation items. Each of the operation items corresponds to a different command to manipulate the at least one terminal device 200. Thus, the command can be sent by operating (e.g., clicking) the operation items.

In step S4, the control module 104 receives the command sent from the user interface manually, and sends the command to the at least one terminal device 200 to control the at least one terminal device 200 to perform a corresponding function.

In step S5, the at least one terminal device 200 returns a feedback of a result of performing the command to the gateway 100. At this time, the result feedback module 105 receives the result and displays the result on the user interface to notify the user.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A device management method using a gateway, the gateway communicating with at least one terminal device and a database server storing a device description frame (DDF) file of each terminal device, the method comprising:
acquiring a device identification (ID) of the at least one terminal device;
downloading the DDF file of the at least one terminal device via a network from the database server according to the device ID;
displaying detailed information of the at least one terminal device on a predetermined user interface according to the downloaded DDF file; and
receiving a command sent from the user interface, and sending the command to the at least one terminal device to control the at least one terminal device to perform a corresponding function.

2. The method according to claim 1, further comprising:
receiving a result of performing the command which is feedback from the at least one terminal device; and
displaying the result on the user interface.

3. The method according to claim 1, further comprising:
storing the DDF file in a storage unit of the gateway.

4. The method according to claim 1, wherein the step of downloading the DDF file comprises:
searching the database server for a download address of the DDF file using the device ID, and linking to the download address via the network to download the DDF file.

5. The method according to claim 1, wherein when the terminal device is connected to the gateway, a dynamic host configuration protocol (DHCP) package is sent from the at least one terminal device to the gateway, and the device ID of the at least one terminal device is acquired from the DHCP package.

6. The method according to claim 5, wherein a download address of the DDF file is pre-configured in the DHCP package.

7. The method according to claim 6, wherein the step of downloading the DDF file comprises;
acquiring the download address of the DDF file from the DHCP package, and linking to the download address via the network to download the DDF file.

8. The method according to claim 1, wherein the user interface comprises a plurality of operation items, each of the operation items corresponds to a different command to manipulate the at least one terminal device, and the command is sent to the at least one terminal device by operating a corresponding operation item.

9. The method according to claim 1, wherein the DDF file is XML-formatted.

10. The method according to claim 1, wherein the gateway is accessed by a control device and the user interface is displayed on a display of the control device.

11. A gateway communicating with at least one terminal device and a database server storing a device description frame (DDF) file of each terminal device, comprising:
a storage unit;
a processor; and
one or more programs executed by the processor to perform a method of:
acquiring a device identification (ID) of the at least one terminal device;
downloading the DDF file of the at least one terminal device via a network from the database server according to the device ID;
displaying detailed information of the at least one terminal device on a predetermined user interface according to the downloaded DDF file; and
receiving a command sent form the user interface, and sending the command to the at least one terminal device to control the at least one terminal device to perform a corresponding function.

12. The gateway according to claim 10, wherein the method further comprises:
receiving a result of performing the command which is feedback from the at least one terminal device; and
displaying the result on the user interface.

13. The gateway according to claim 10, wherein the method further comprises:
storing the DDF file in the storage unit of the gateway.

14. The gateway according to claim 10, wherein the step of downloading the DDF file comprises:
searching the database server for a download address of the DDF file using the device ID, and linking to the download address via the network to download the DDF file.

15. The gateway according to claim 10, wherein when the terminal device is connected to the gateway, a dynamic host configuration protocol (DHCP) package is sent from the at least one terminal device to the gateway, and the device ID of the at least one terminal device is acquired from the DHCP package.

16. The gateway according to claim 15, wherein a download address of the DDF file is pre-configured in the DHCP package.

17. The gateway according to claim 16, wherein the step of downloading the DDF file comprises;
acquiring the download address of the DDF file from the DHCP package, and linking to the download address via the network to download the DDF file.

18. The gateway according to claim 10, wherein the user interface comprises a plurality of operation items, each of the operation items corresponds to a different command to manipulate the at least one terminal device, and the command is sent to the at least one terminal device by operating a corresponding operation item.

19. The gateway according to claim 10, wherein the DDF file is XML-formatted.

20. The gateway according to claim 10, wherein the gateway is accessed by a control device and the user interface is displayed on a display of the control device.
